(19) United States
(12) Patent Application Publication
(10) Pub. No.: US 2010/0042777 A1
(43) Pub. Date: Feb. 18, 2010

(54) SEMICONDUCTOR DEVICE INCLUDING MEMORY CELL HAVING CHARGE ACCUMULATION LAYER AND CONTROL GATE AND DATA WRITE METHOD FOR THE SAME

(76) Inventor: Hidetaka TSUJI, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/508,992

(22) Filed: Jul. 24, 2009

(30) Foreign Application Priority Data
Aug. 13, 2008 (JP) 2008-208649

(51) Int. Cl. G06F 12/02; G06F 12/00

(52) U.S. Cl. 711/103; 365/185.11; 711/E12.001; 711/E12.008

(57) ABSTRACT

A semiconductor device includes a nonvolatile semiconductor memory and a controller. The nonvolatile semiconductor memory includes a first memory block configured to hold at least 2 bits data, and a second memory block configured to hold 1-bit data. The data is programmed into the first and second memory blocks in units of page. Each of the pages in the first memory block is assigned to a corresponding bit of the held data. Time required for write varies depending on the bit. The controller instructs the nonvolatile semiconductor memory to program the write data into the first memory block or the second memory block. The controller instructs the nonvolatile semiconductor memory to program the data on any of the pages in the second memory block if a final page of the write data corresponds to the bit requiring the longest time for the write.

### CROSS-REFERENCE TO RELATED APPLICATIONS

This application is based upon and claims the benefit of priority from prior Japanese Patent Application No. 2008-208649, filed Aug. 13, 2008, the entire contents of which are incorporated herein by reference.

### BACKGROUND OF THE INVENTION

1. Field of the Invention

The present invention relates to a semiconductor device and a data write method for the semiconductor device. The present invention relates to, for example, a memory system including a nonvolatile memory and a controller controlling the operation of the memory.

2. Description of the Related Art

In a NAND flash memory, data is written to a plurality of memory cells at a time. The unit of this batch write is called a page. Write of data to the NAND flash memory is disclosed in, for example, Jpn. Pat. Appln. KOKAI Publication No. 2007-242163. In recent years, the page size has been increasing consistently with the capacity of the NAND flash memory. Thus, the capability of writing large-sized data to the NAND flash memory has been improved.

However, accesses from a host apparatus to the NAND flash memory do not always involve a large data size. In particular, if the size of data to be written is smaller than the page size, the NAND flash memory may fail to sufficiently exercise the write capability. This may reduce the speed of the write.

### BRIEF SUMMARY OF THE INVENTION

A semiconductor device according to an aspect of the present invention includes:

a nonvolatile semiconductor memory including a first memory block having a plurality of memory cells configured to hold data of at least 2 bits, and a second memory block having a plurality of memory cells configured to hold 1-bit data, the nonvolatile semiconductor memory being configured such that data is programmed into the first and second memory blocks in units of page which is a set of a plurality of the memory cells, each of the pages in the first memory block being assigned to a corresponding bit of the held data, time required for write varying depending on the bit; and

a controller supplying write data received from a host apparatus to the nonvolatile semiconductor memory and instructing the nonvolatile semiconductor memory to program the write data into the first memory block or the second memory block for each of the pages, the controller instructing the nonvolatile semiconductor memory to program the data on any of the pages in the second memory block if a final page of the write data corresponds to the bit requiring the longest time for the write.

A data write method for a nonvolatile semiconductor memory including a first memory block offering a write speed varying with page and a second memory block, the method according to an aspect of the present invention includes:

transmitting a first row address specifying any of the pages in the first memory block to the nonvolatile semiconductor memory;

after transmitting the first row address, transmitting data to the nonvolatile semiconductor memory;

if after the transmission of the data, no data to be transmitted to the nonvolatile semiconductor memory remains, and the first row address corresponds to the page offering the lowest write speed in the first memory block, transmitting a row address change instruction and a second row address specifying any of the pages in the second memory block to the nonvolatile semiconductor memory; and

after the transmission of the second row address, transmitting a write instruction to program the data on a page specified by the second row address, to the nonvolatile semiconductor memory.

### BRIEF DESCRIPTION OF THE SEVERAL VIEWS OF THE DRAWING

FIG. 1 is a block diagram of a memory system according to a first embodiment of the present invention;

FIG. 2 is a diagram showing the assignment of signals to signal pins in a memory card according to the first embodiment;

FIGS. 3 and 4 are block diagrams of a card controller and a flash memory, respectively, according to the first embodiment;

FIG. 5 is a circuit diagram of a memory block according to the first embodiment;

FIG. 6 is a graph showing the threshold distribution of a memory cell transistor according to the first embodiment;

FIG. 7 is a schematic diagram of the memory block according to the first embodiment;

FIG. 8 is a flowchart showing a data write method according to the first embodiment;

FIG. 9 is a timing chart of signals output by a card controller according to the first embodiment;

FIG. 10 is a flowchart showing a data write method according to the first embodiment;

FIG. 11 is a timing chart showing the flow of data and operation in the data write method according to the first embodiment;

FIGS. 12 to 16 are timing charts showing the flow of data and operation;

FIG. 17 is a timing chart showing the flow of data and operation in a data write method according to a second embodiment;

FIG. 18 is a block diagram of a memory card according to the first and second embodiments;

FIGS. 19 and 20 are timing charts showing the flow of operation in the data write methods according to the first and second embodiments; and

FIG. 21 is a timing chart showing the flow of operation in the data write methods according to the first and second embodiments.

### DETAILED DESCRIPTION OF THE INVENTION

### First Embodiment

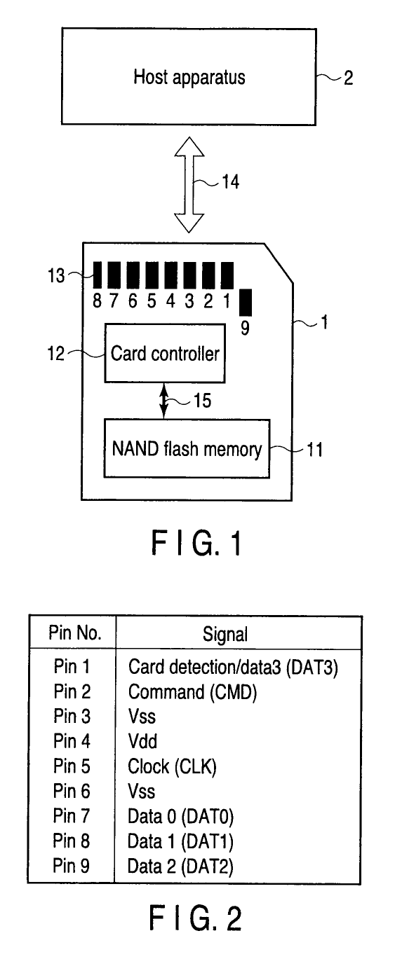

A semiconductor device according to a first embodiment of the present invention will be described with reference to FIG. 1. FIG. 1 is a block diagram of a memory system according to the present embodiment.

### <General Configuration of the Memory System>

As shown in the drawings, the memory system includes a memory card 1 and a host apparatus 2. The host apparatus 2 includes hardware and software required to access a memory card 1 connected to the host apparatus via a host bus interface (hereinafter sometimes simply referred to as a host bus) 14. When connected to the host apparatus 2, the memory card 1 receives a power supply to operate. The memory card 1 thus executes processing corresponding to an access from the host apparatus 2.

### <Configuration of the Memory Card>

The memory card 1 transmits and receives data to and from the host apparatus 2 via the host bus interface 14. The memory card 1 includes a NAND flash memory chip (hereinafter sometimes simply referred to as a NAND flash memory or flash memory) 11, a card controller 12 that controls a flash memory chip 11, and a plurality of signal pins (first to ninth pins) 13.

The plurality of signal pins 13 are electrically connected to the card controller 12. Signals are assigned to the plurality of pins, the first to ninth pins, for example, as shown in FIG. 2. FIG. 2 is a table showing the first to ninth pins and the signals assigned to the pins.

Data 0 to 3 are assigned to the seventh pin, the eighth pin, the ninth pin, and the first pin, respectively. The first pin is also assigned to a card detection signal. The second pin is assigned to a command. The third and sixth pins are assigned to a ground potential Vss. The fourth pin is assigned to a power supply potential Vdd. The fifth pin is assigned to a clock signal.

The memory card 1 is formed to be inserted into and removed from a slot provided in the host apparatus 2. A host controller (not shown in the drawings) provided in the host apparatus 2 communicates various signals and data to and from the card controller 12 in the memory card 1 via the first to ninth pins. For example, data is written to the memory card 1, the host controller transmits a write command to the card controller 12 via the second pin as a serial signal. In this case, the card controller 12 retrieves the write command provided to the second pin in response to the clock signal.

Here, as described above, the write command is serially input to the card controller 12 utilizing only the second pin. The second pin to which the input of the command is assigned is located between the first pin for the data 3 and the third pin for the ground potential Vss as shown in FIG. 2. The plurality of pins 13 and the corresponding host interface 14 are used to allow the host controller in the host apparatus 2 and the memory card 1 to communicate.

In contrast, the flash memory 11 and the card controller 12 communicate via a NAND bus interface (hereinafter sometimes simply referred to as a NAND bus) 15 for the NAND flash memory. Thus, although not shown in the drawings, the flash memory 11 and the card controller 12 are connected together via, for example, an 8-bit I/O line.

For example, to write data to the flash memory 11, the card controller 12 sequentially inputs a data input command 80H, a column address, a page address, data, and a program command 10H (or a cache program command 15H) to the flash memory 11 via the I/O line. Here, “H” in the command 80H denotes a hexadecimal number. In actuality, an 8-bit signal “10000000” is provided to the 8-bit I/O line in parallel. That is, a plurality of bits of command are provided in parallel via the NAND bus interface 15.

Furthermore, in the NAND bus interface 15, commands and data are communicated to and from the flash memory 11 using the same I/O line. Thus, the interface (host bus 14) via which the host controller in the host apparatus 2 and the memory card 1 communicate is different from the interface (NAND bus 15) via which the flash memory 11 and the card controller 12 communicate.

### <Configuration of the Memory Controller>

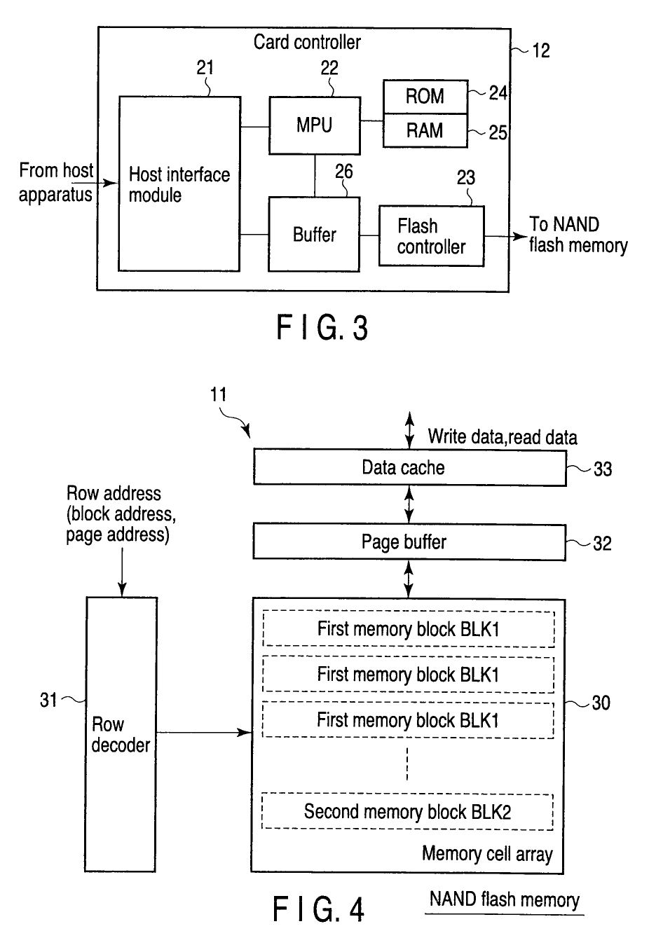

Now, the internal configuration of the card controller provided in the memory card 1 shown in FIG. 1 will be described with reference to FIG. 3. FIG. 3 is a block diagram of the card controller 12.

The card controller 12 manages the physical state of the interior of the flash memory 11 (for example, what block address includes what number logical sector address data or which block is in the erased state). The card controller 12 has a host interface module 21, microprocessing unit (MPU) 22, flash controller 23, read-only memory (ROM) 24, random access memory (RAM) 25, and buffer 26.

The host interface module 21 executes the interface processing between the card controller 12 and the host apparatus 2.

MPU 22 controls the operation of the memory card 1 as a whole. MPU 22 utilizes firmware stored in ROM 24, a part of firmware stored in RAM 25, and various tables stored in RAM 25 to fulfill requests in commands from the host apparatus.

ROM 24 stores firmware executed by MPU 22. RAM 25 is used as a work area for MPU 22, and stores the firmware and various tables. The flash controller 23 executes the interface processing between the card controller 12 and the flash memory 11.

The buffer 26, when writing the data sent from the host apparatus 2 to the flash memory 11, temporarily stores a specific amount of data (e.g., one page of data) or, when sending the data read from the flash memory 11 to the host apparatus 2, temporarily stores a specific amount of data.

### <Configuration of the NAND Flash Memory>

Now, the internal configuration of the NAND flash memory 11 will be described in brief. FIG. 4 is a block diagram of the NAND flash memory 11. As shown in FIG. 4, the NAND flash memory 11 includes a memory cell array 30, a row decoder 31, a page buffer 32, and a data cache 33.

### <Memory Cell Array>

First, the memory cell array 30 will be described. The memory cell array 30 includes a first memory block BLK1 and a second memory block BLK2. FIG. 4 illustrates a plurality of first memory blocks BLK1 and one second memory block BLK2. However, for both the first memory block BLK1 and the second memory block BLK2, at least one memory block has only to be provided. The first memory block BLK1 and the second memory block BLK2 have basically the same configuration. Thus, when need not be distinguished from each other below, the first memory block BLK1 and the second memory block BLK2 are both referred to as the memory block BLK.

The memory block BLK includes a plurality of memory cell transistors that can hold data. The second memory block BLK2 is used as a cache region for the first memory blocks BLK1. That is, the second memory block BLK2 is used as a region in which data to be programmed is temporally held. This will be described below. The data is erased in BLK unit. That is, the data in the same memory cell block BLK is deleted at a time.

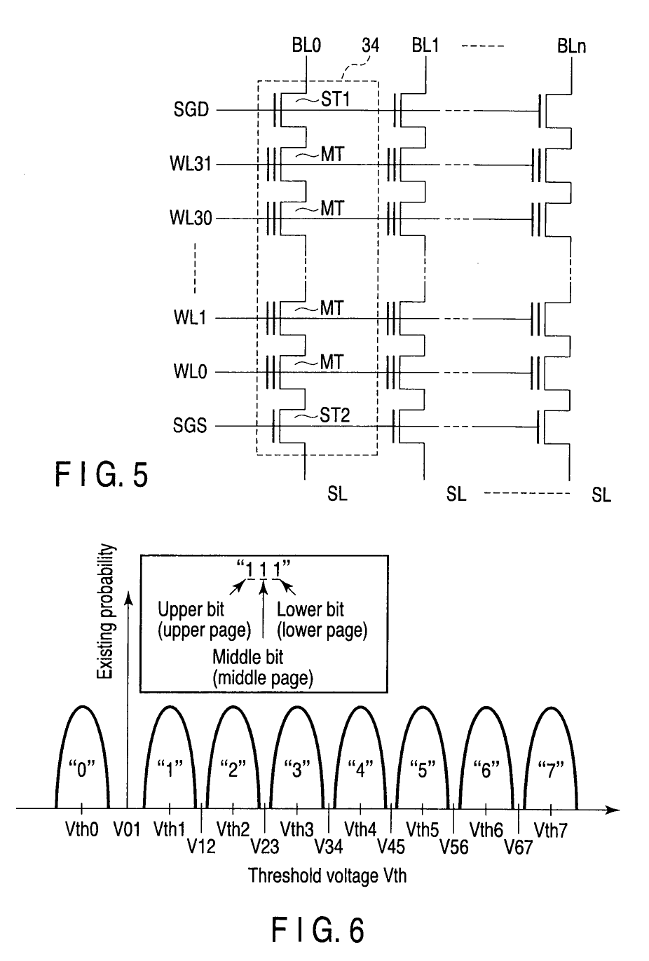

The configuration of the memory block BLK will be described with reference to FIG. 5. FIG. 5 is a circuit diagram of the memory block BLK. As shown in FIG. 5, each of the memory blocks BLK includes (n+1) (n is an integer equal to or larger than 0) memory cell units 34.

Each of the memory cell units 34 includes, for example, 32 memory cell transistors MT and select transistors ST1 and ST2. Each of the memory cell transistors includes a stack gate structure having a charge accumulation layer (for example, a floating gate) formed on a semiconductor substrate via a gate insulating film, and a control gate formed on the charge accumulation layer with an inter-gate insulating film interposed therebetween. The number of memory cell transistors MT is not limited to 32 and may be 8, 16, 64, 128, 256, or the like; no limitation is imposed on the number of memory cell transistors MT. The adjacent memory cell transistors share a source and a drain. Current paths in the memory cell transistors MT are connected together in series between the select transistors ST1 and ST2. A drain of one of the series connected memory cell transistor MT which is located at one end of the arrangement of the memory cell transistors MT is connected to a source of the select transistor ST1. A source of one of the series connected memory cell transistor MT which is located at the other end of the arrangement is connected to a drain of the select transistor ST2.

In each of the memory blocks BLK, control gates of the memory cell transistors MT arranged on the same row are connected to one of word lines WL0 to WL31 in common. Gates of the select transistor ST1 and ST2 for the memory cell transistors arranged on the same row are connected to select gate lines SGD and SGS in common, respectively. For simplification of description, the word lines WL0 to WL31 are sometimes simply referred to as the word lines WL below. Sources of the select transistors ST2 are connected to a source line SL in common. Not both the select transistors ST1 and ST2 are required. One of the select transistors ST1 and ST2 may be omitted provided that any of the memory cell units 34 can be selected.

In a plurality of memory blocks BLK, a drain of the select transistor ST1 in each of the memory cell units 34 is connected to one of bit lines BL0 to BLn in common. The sources of the select transistors ST2 are all connected to the source line SL.

Data that can be taken by the memory cell transistors MT will be described. First, the first memory block BLK will be described. The memory cell transistors MT included in the first memory block BLK1 is configured to hold 3-bit data according to a threshold voltage. FIG. 6 is a graph showing the threshold distribution of the memory cell transistors MT included in the first memory block BLK1. The graph shows a threshold voltage Vth on the abscissa and the existing probability of the memory cell transistor MT on the ordinate.

As shown in FIG. 6, each of the memory cell transistors MT can hold data of one of eight levels. More specifically, the memory cell transistor MT can hold one of eight types of data “0”, “1”, “3”, . . . , “7”, arranged in order of increasing threshold voltage Vth. In the memory cell transistor MT, the threshold voltage Vth0 of “0” data is Vth0<V01. The threshold voltage Vth1 of “1” data is V01<Vth1<V12. The threshold voltage Vth2 of “2” data is V12<Vth2<V23. The threshold voltage Vth3 of “3” data is V23<Vth3<V34. The threshold voltage Vth4 of “4” data is V34<Vth4<V45. The threshold voltage Vth5 of “5” data is V45<Vth5<V56. The threshold voltage Vth6 of “6” data is V56<Vth6<V67. The threshold voltage Vth7 of “7” data is V67<Vth7.

That is, each of the memory cell transistors MT in the first memory block BLK1 can hold 3-bit data “000” to “111”. The bits of the 3-bit data are hereinafter referred to as a lower bit, a middle bit, and an upper bit as shown in FIG. 6. It is possible to appropriately select the correspondence relationship between the 8-level data “0” to “7” that can be taken by each of the memory cell transistor MT and the binary number expression of these data “000” to “111”.

Now, the second memory block BLK2 will be described. Each of the memory cell transistors MT included in the second memory block BLK2 can hold 1-bit data according to the threshold voltage. That is, the memory cell transistor MT holds one of the “0” data and the “1” data according to the threshold voltage.

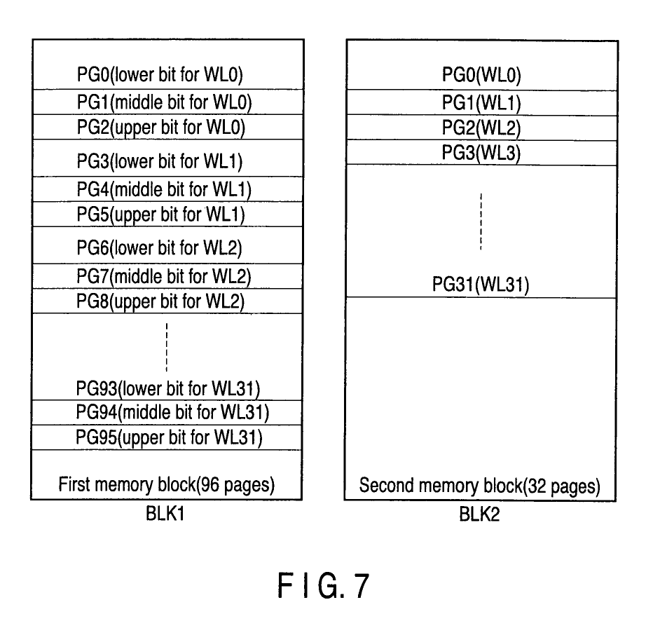

In the memory block BLK configured as described above, data is written at a time to all the memory cell transistors MT connected to the same word line WL. This unit is hereinafter referred to as a page. For the memory cell transistors MT in the first memory block BLK1, each of which can hold 3-bit data, data is written to the memory cell transistor for each bit. That is, first, the data is written in order of the lower bit, the middle bit, and the upper bit. Consequently, in the first memory block BLK1, three pages are assigned to each word line WL. A page corresponding to the lower bit is hereinafter sometimes referred to as a lower page. A page corresponding to the middle bit is hereinafter sometimes referred to as a middle page. A page corresponding to the upper bit is hereinafter sometimes referred to as a upper page. On the other hand, in the second memory block, one page is assigned to each word line WL. This is shown in FIG. 7. FIG. 7 is a schematic diagram showing pages included in the first memory block BLK1 and the second memory block BLK2.

As shown in FIG. 7, in the first memory block BLK1, three pages are assigned to each word line WL, and the number of the word lines WL is 32. Thus, pages PG0 to PG95 are assigned to the first memory block BLK1. The total number of pages is 96. Therefore, the memory size of the first memory block BLK1 is (96×(n+1)) bits.

On the other hand, in the second memory block BLK2, one page is assigned to each word line WL, and the number of the word lines WL is 32. Thus, pages PG0 to PG31 are assigned to the second memory block BLK2. The total number of pages is 32. Therefore, the memory size of the second memory block BLK1 is (32×(n+1)) bits.

Data need not be written at a time to all the memory cell transistors MT connected to one of the word lines WL. For example, for each word line, data may be written every even-numbered bit line or every odd-numbered bit line. In this case, the number of pages in the first memory block BLK1 is double the above-described value, 192.

### <Row Decoder>

Now, FIG. 4 is referred to again. The row decoder 31, provided in the NAND flash memory 11, will be described. The row decoder 31 receives a row address from the card controller 12 to decode the row address. The row address includes a block address specifying one of the memory blocks BLK and a page address specifying one of the pages. Based on the row address, the row decoder 31 selects one of the word lines WL in one of the memory blocks BLK.

### <Data Cache>

The data cache 33 is configured to temporarily hold page-sized data.

The data cache 33 transmits and receives data to and from the card controller 12. That is, to allow data to be read, the data cache 33 transfers the data provided by the page buffer 32 to the card controller 12. To allow data to be written, the data cache 33 receives the data provided by the card controller 12 and then transfers the data to the page buffer 32 in page unit.

### <Page Buffer>

The page buffer 32 is configured to temporarily hold page-sized data.

To allow data to be read, the page buffer 32 temporarily hold data read from the memory array 30 in page unit and then transfers the data to the data cache 33. To allow data to be written, the page buffer 32 transfers data transferred from the data cache 33 to the bit lines BL0 to BLn to program the data in page unit.

Data write is performed by repeating the above-described programming and verification. The programming refers to an operation of injecting electrons into the charge accumulation layer y generating a difference in potential between the control gate and channel of the memory cell transistor MT. The verification is an operation of reading data from the programmed memory cell transistor MT to determine whether or not the threshold voltage of the memory cell transistor MT has a desired value.

### <Data Programming Method>

Now, a data programming method in the memory card 1 configured as described above will be described. First, processing mainly executed by the card controller 12 will be described.

### <Operation of the Card Controller 12>

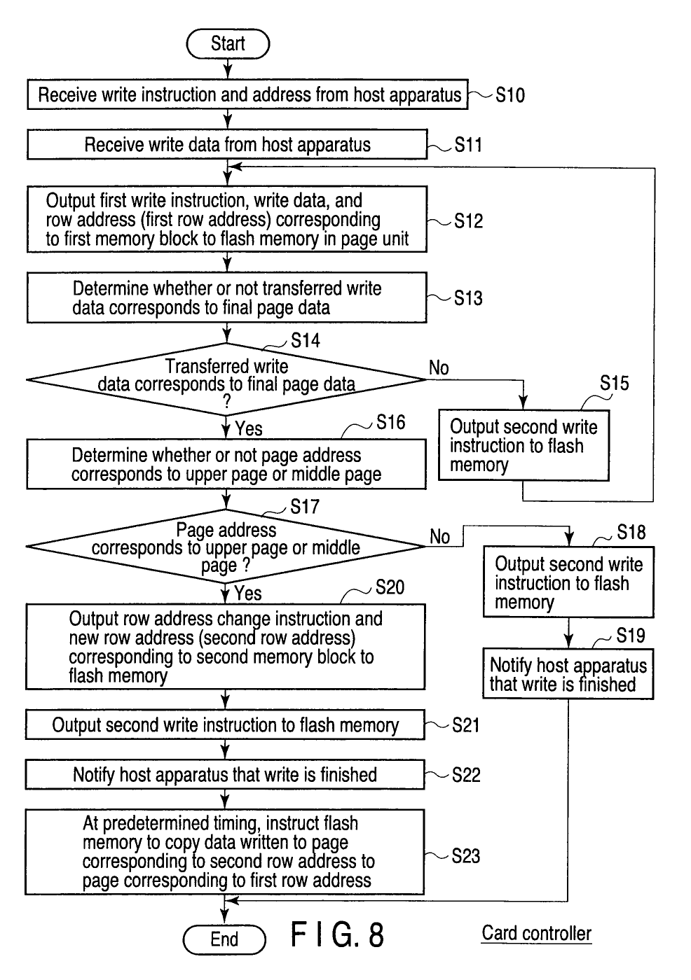

FIG. 8 is a flowchart showing processing executed by the card controller 12 during data programming.

As shown in FIG. 8, first, the card controller 12 receives a data write instruction and an address in the NAND flash memory 11 at which data is to be written, from the host apparatus 2 via the host bus 14 (step S10). Subsequently, the card controller 12 receives write data from the host apparatus 2 via the host bus 14 (step S11). The write data is temporarily held in the buffer 26. The card controller 12 outputs a first write instruction, write data, and an address to the flash memory 11 via the NAND bus 15.

The flash memory 11 receives the first write instruction to recognize that a write operation is started and write data is to be transferred. The first write instruction corresponds to, for example, a command “80H” in the NAND flash memory. However, the data is actually programmed into the memory cell transistor MT when a second write instruction described below is provided. Furthermore, although the address output by the card controller 12 includes a column address specifying the column direction of the memory cell array 30 and a row address specifying the row direction of the memory cell array 30, the description below notes only the row address. In step S12, for example, the MCU 22 in the card controller 12 issues and outputs a row address (hereinafter referred to as a first row address) corresponding to the first memory block.

Subsequently, the MCU 22 in the card controller 12 determines whether or not the transferred write data is final page data (step S13). That is, the MCU 22 determines whether or not any write data to be transferred remains as a result of the transfer of the write data in step S12.

For example, given that the write data transferred from the host apparatus 2 has a size corresponding to two pages. Since the card controller 12 transfers the write data and the first row address for every page, two data transfers are required to transfer all of the write data. When the first data transfer is finished, one page of write data remains to be transferred. Thus, the MCU 22 determines that the final page data has not been transferred (step S14, NO). On the other hand, when the second data transfer is finished, no write data remains to be transferred. Thus, the page to which the data transferred during the second transfer is final for the write data. Consequently, the MCU 22 determines that the data has been written to the final page.

In step S13, the MCU 22 has only to determine whether or not the page on which the write data is programmed is final. Whether or not the data size is equal to the page size is not important. That is, the final data may have a size smaller than the page size.

Furthermore, in terminating the write access, the host apparatus 2 outputs a write access end notification to the card controller 12. To suspend the write access, the host apparatus 2 outputs a suspend instruction. Thus, the determination in step S13 can be performed by, for example, determining whether the host apparatus 2 has output the write access end notification or the suspend instruction.

Upon determining, as a result of step S13, that the page data is not final (step S14, NO), the MCU 22 in the card controller 12 issues and outputs a second write instruction to the flash memory 11 via the NAND bus 15 (step S15). The second write instruction corresponds to, for example, a command “10H” or “15H” in the NAND flash memory. Thereafter, the card controller 12 returns to step S12 to continue to transfer the succeeding write data to the flash memory 11.

Upon determining, as a result of step S13, that the page data is final (step S14 YES), the MCU 22 determines whether the page address for the page data corresponds to an upper page or a middle page (step S16). That is, the MCU 22 determines that the page address indicates a page PG (3i+1) or a page (3i+2) in the first memory block BLK1 shown in FIG. 7 (i is an integer in the range 0 to 31).

Upon determining, as a result of step S16, that the page address corresponds to the lower page (step S17, NO), that is, the page address indicates a page PG (3i), the MCU 22 issues the second write instruction. The MCU 22 then outputs the second write instruction to the flash memory 11 via the NAND bus 15 (step S18). Thereafter, the MCU 22 notifies the host apparatus 19, via the host bus 14, that the write is completed (step S19).

Upon determining, as a result of step S16, that the page address corresponds to the upper page or the middle page (step S17, YES), the MCU 22 issues and outputs a row address change instruction and a new row address (hereinafter referred to as a second row address) to the flash memory 11 (step S20). The second row address corresponds to one of the pages in the second memory block BLK2. Then, as is the case with steps S18 and S19, the MCU 22 outputs the second write instruction to the flash memory 11 (step S21). The MCU 22 further notifies the host apparatus 19 that the write is completed (step S22).

Thereafter, at a predetermined timing, the MCU 22 instructs the flash memory 11 to copy the data programmed on the page corresponding to the second row address to the page corresponding to the first row address, that is, the page to be originally programmed (step S23). The predetermined timing corresponds to the moment when the host apparatus performs the next write access.

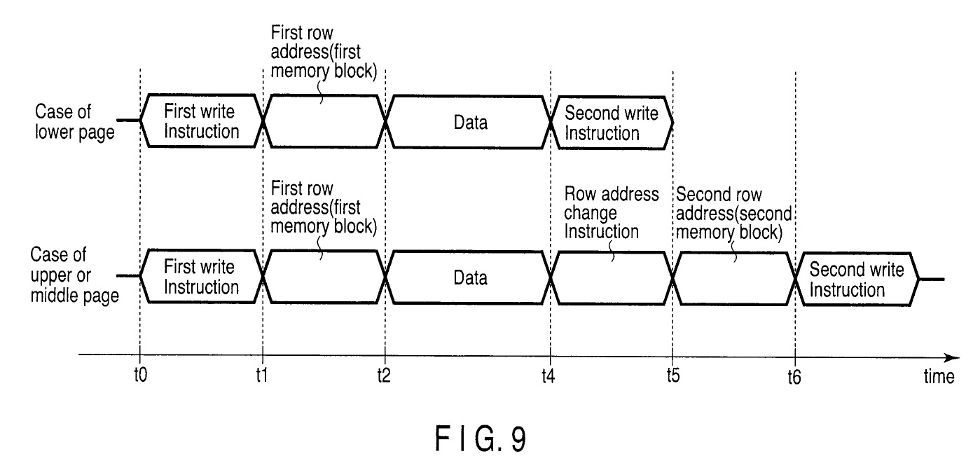

In the above-described processing, signals provided to the flash memory 11 via the NAND bus 15 by the card controller 12 will be described with reference to FIG. 9. FIG. 9 is a timing chart of the signals output to the flash memory 11 by the card controller 12. In FIG. 9, the upper stage shows a case where the MCU determines, in step S16, that the “page address does not correspond to the upper or middle page” (step S17, NO). The lower stage shows a case where the MCU determines, in step S16, that the “page address corresponds to the upper or middle page” (step S17, YES).

As shown in FIG. 9, in either case, at time t0, the first write instruction is output. Thereafter, at times t1 and t2, the address (first row address) and write data, respectively, are sequentially output. Then, if the end or suspend instruction is not issued, then at time t4, the second write instruction is output to complete the flow of the series of signals. On the other hand, if the end or suspend instruction is issued, then at time t4, a row address change instruction is output to, and at time t5, a new row address (second row address) is output. Thereafter, at time t6, the second write instruction is output. In the latter case, the first row address, output at time t1, but the second row address, output at time t5, is effective. The second row address corresponds to the second memory block BLK2, which is different from the first memory block BLK1, corresponding to the first row address.

### <Operation of the NAND Flash Memory 11>

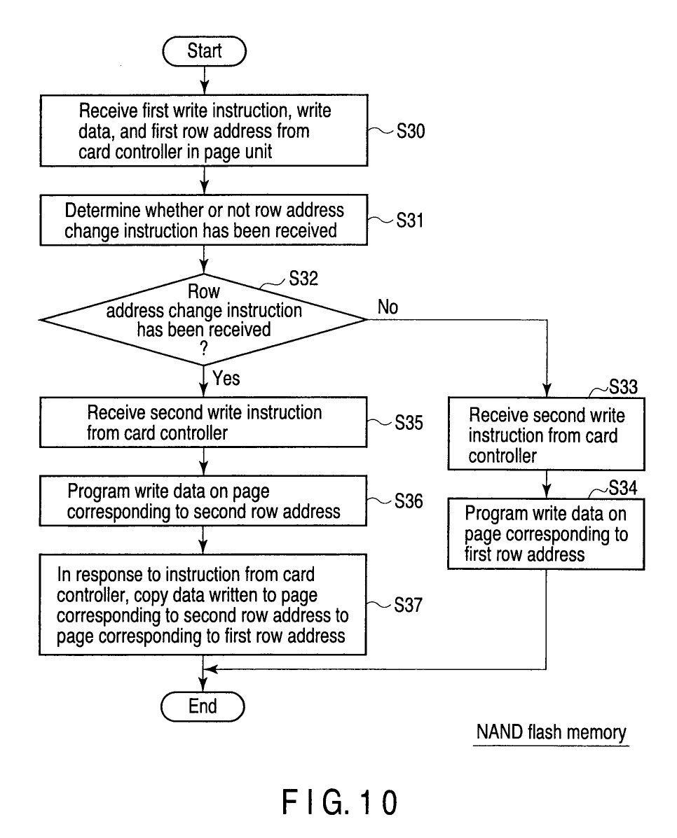

Now, processing mainly executed by the NAND flash memory 11 will be described with reference to FIG. 10. FIG. 10 is a flowchart showing the processing in the flash memory 11.

As shown in FIG. 10, first, the flash memory 11 receives a first write instruction, write data, and a first row address (and a column address) from the card controller 12 via the NAND bus 15 in page unit (step S30). The received write data is held in the page buffer 32 via the data cache 33. The first row address is provided to the row decoder 31. The first write instruction is provided to a control section (not shown in FIG. 4) controlling the operation of the flash memory 11 as a whole.

Subsequently, the flash memory 11 determines whether or not a row address change instruction and a second row address have been received (step S31). If the row address change instruction and the second row address have not been received (step S32, NO), the flash memory 11 receives the second write instruction from the card controller 12 (step S33). The flash memory 11 then writes data to the page specified by the first row address and column address received in step S30 (step S34). That is, the write data is written to one of the pages in the first memory block BLK1.

In step S32, if the row address change instruction has been received (step S32, YES), the flash memory 11 receives the second write instruction (step S35). The flash memory 11 then writes data to the page specified by the column address received in step S30 and the second row address received after the row address change instruction (step S36). That is, the write data is written to one of the pages in the second memory block BLK2.

Thereafter, the flash memory 11 copies the data written to the second memory block BLK2 in step S36, to the page specified by the first row address received in step S30 (step S37).

### <Specific Example of the Write Operation>

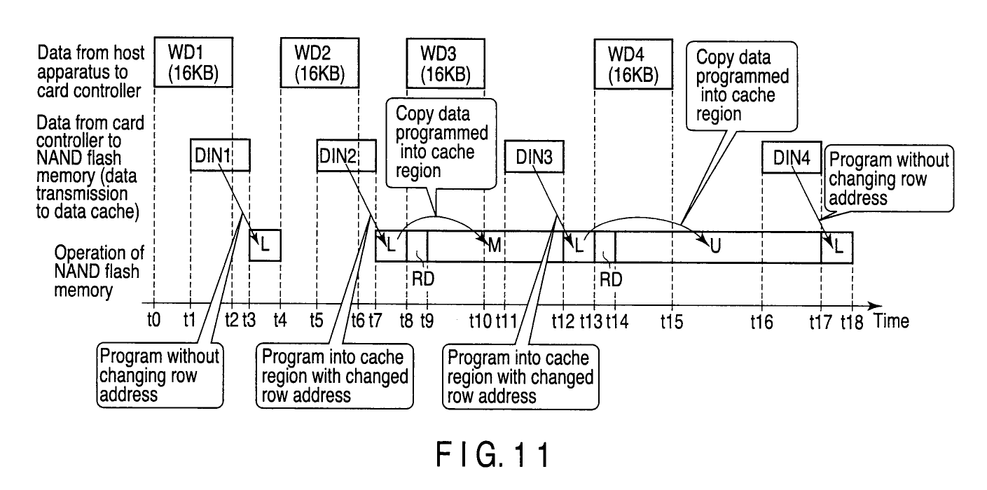

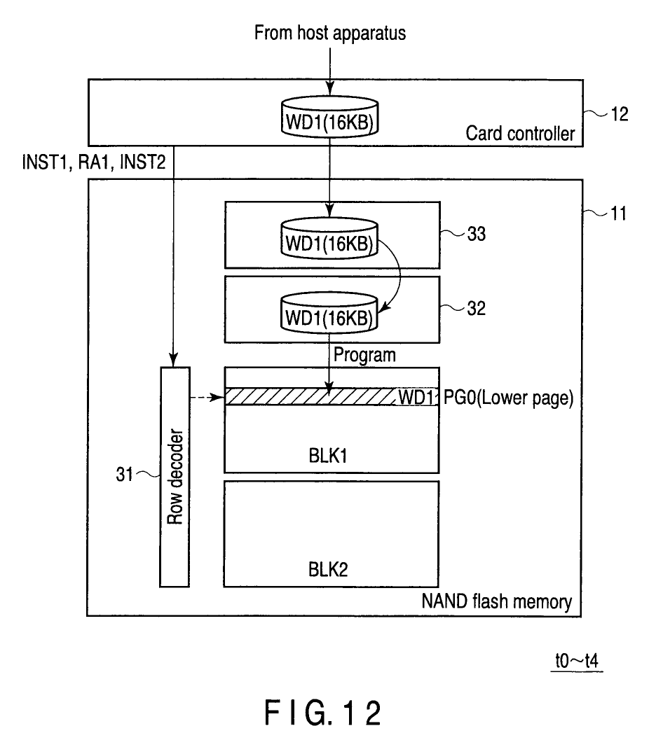

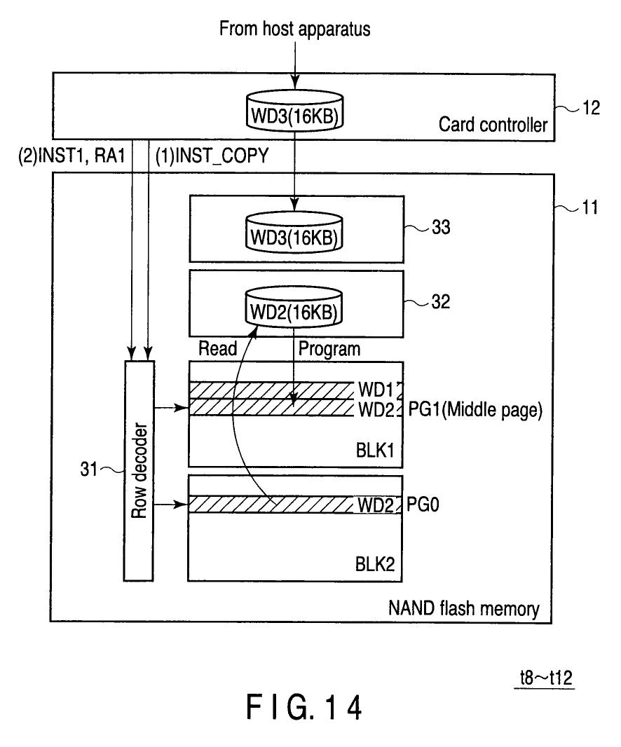

A specific example of the programming operation will be described with reference to FIGS. 11 to 15. FIG. 11 is a timing chart showing the flow of processing executed by the memory system according to the present embodiment. FIG. 11 shows the flow of data from the host apparatus 2 to the memory controller 12 (the flow of data on the host bus 14), the flow of data from the memory controller 12 to the data cache 33 in the NAND flash memory 11 (the flow of data on the NAND bus 15), and the flow of the operation of the NAND flash memory 11. FIGS. 12 to 15 are block diagrams in which a shaded region shows a page on which write data has been programmed. In the description below, by way of example, the data size of one page is 16 KB, and the host apparatus performs four write accesses for page-sized data.

In the description below, by way of example, if the data transferred to the NAND flash memory 11 corresponds to the final page (step S14, YES), that is, if no succeeding data remains, the card controller 12 issues a normal program command “10H” as the second write instruction. If the data transferred to the NAND flash memory 11 does not correspond to the final page (step S14, NO), that is, if succeeding data remains, the card controller 12 issues a cache program command “15H” as the second write instruction.

If the cache program command “15H” is issued, the NAND flash memory 11 executes cache programming. In the cache programming, when the data cache 33 becomes empty, that is, before the data write is completed, the NAND flash memory 11 becomes ready to accept the next data. In contrast, if the normal program command “10H” is issued, the NAND flash memory 11 becomes ready after the data write is completed, that is, after the verification has finished.

(Time t0 to t4)

First, the operation between times t0 and t4 will be described with reference to FIGS. 11 and 12. As shown in FIGS. 11 and 12, at time t0, the host apparatus 2 makes a write access to the memory card 1 and transfers 16-KB write data WD1. Then, the card controller 12 issues and outputs a first write instruction INST1 and a first row address RA1 to the flash memory 11. The first row address is assumed to correspond to a page PG0 in the first memory block BLK1.

Subsequently, at time t1, the card controller 12 transfers received write data WD1 to the flash memory 11 (this operation is denoted by DIN1 in FIG. 11). Write data WD1 is stored in the data buffer 33 and further transferred to the page buffer 32.

Thereafter, at time t3, the card controller 12 issues and outputs a second write instruction INST2 to the flash memory 11. The first row address RA1 corresponds to the lower page. Thus, no row address change instruction is issued. Furthermore, no succeeding data remains. Thus, the issued second write instruction INST2 is the normal program command “10H”.

When the second write instruction INST2 is issued, the flash memory 11 becomes busy state and writes data WD1 to the memory cell transistor MT. This operation is denoted by “L” in FIG. 11. That is, the row decoder 31 selects page PG0 according to the first row address RA1. Then, the programming and verification are performed on page PG0 to write WD1 to page PG0. Thereafter, the NAND flash memory 11 becomes ready state.

(Between Times t4 and t8)

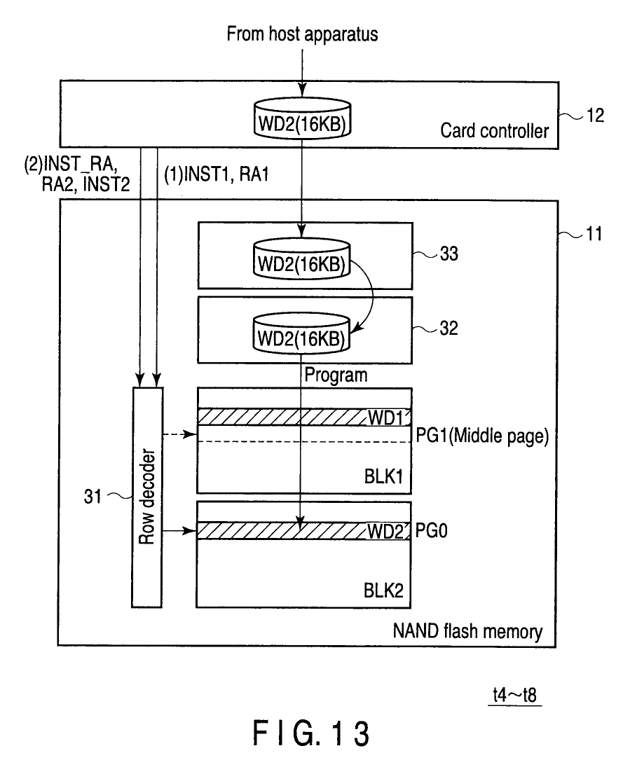

Now, the operation between times t4 and t8 will be described with reference to FIGS. 11 and 13. As shown in FIG. 11, at time t4 when the writing of write data WD1 is finished, the host apparatus 2 makes a write access to the memory card 1 and transfers 16-KB write data WD2. The card controller 12 then issues and outputs the first write instruction INST1 and the first row address RA1 to the flash memory 11. The first row address corresponds to page PG1 in the first memory block BLK1.

Subsequently, at time t5, the card controller 12 transfers received write data WD2 to the flash memory 11 (this operation is denoted by DIN2 in FIG. 11). At this time, the first row address RA1 corresponds to the middle page. Thus, the card controller 12 issues and outputs a row address change instruction INST_RA and a second row address RA2 to the flash memory 11. The card controller 12 then issues and outputs a second write instruction INST2=“10H” to the flash memory 11. The second row address RA2 is assumed to correspond to, for example, page PG0 in the second memory block BLK2.

In the flash memory 11, in response to the issued row address change instruction INST_RA, the row decoder 31 selects page PG0 in the second memory block BLK2 instead of page PG1 in the first memory block BLK1. Thus, write data WD2 is written to page PG0 in the second memory block BLK2.

(Time t8 to t12)

Now, the operation between times t8 and t12 will be described with reference to FIGS. 11 to 14. As shown in FIG. 11, at time t8 when the writing of write data WD2 is finished, the host apparatus 2 makes the next write access to the memory card 1 to start transferring 16-KB write data WD3.

During the period in which write data WD3 is transferred, an operation of copying data WD2 is performed in the memory card 1. That is, data WD2 written to the second memory block BLK2 is copied to page PG1 in the first memory block BLK1 on which the data is to be originally written. In the copy operation, at time t8, the card controller 12 issues and outputs a copy instruction INST_COPY to the flash memory 11.

In response to the copy instruction INST_COPY, the row decoder 31 in the flash memory 11 selects page PG0 in the second memory block BLK2. Then, write data WD2 is read into the page buffer 32. This operation is denoted by “RD” in FIG. 11. Subsequently, at time t9, the row decoder 31 selects page PG1 in the first memory block BLK1 to write data WD2 to page PG1 in the first memory block BLK1. This operation is denoted by “M” in FIG. 11. Although not shown in FIG. 11, when the data read is completed at time t9, the card controller 12 issues a second write instruction INST2 in order to instruct the NAND flash memory 11 to write the read data WD2 to page PG1 in the first memory block BLK1. The second write instruction INST2 issued in this case is the cache program command “15H” because write data WD3 succeeding the read data is present.

Utilization of the cache programming makes the NAND flash memory 11 ready state at time t11 when write data WD2 is being copied. Thus, between times t11 and t12, the card controller 12 issues and outputs the first write instruction INST1 and first row address RA1 for next write data WD3 to the flash memory 11. The card controller 12 subsequently transfers write data WD3 to the data cache 33 (this operation is denoted by DIN3). The transfer of write data WD3 and the operation of copying data WD2 are desirably simultaneously finished in terms of efficiency.

(Between Times t12 and t13)

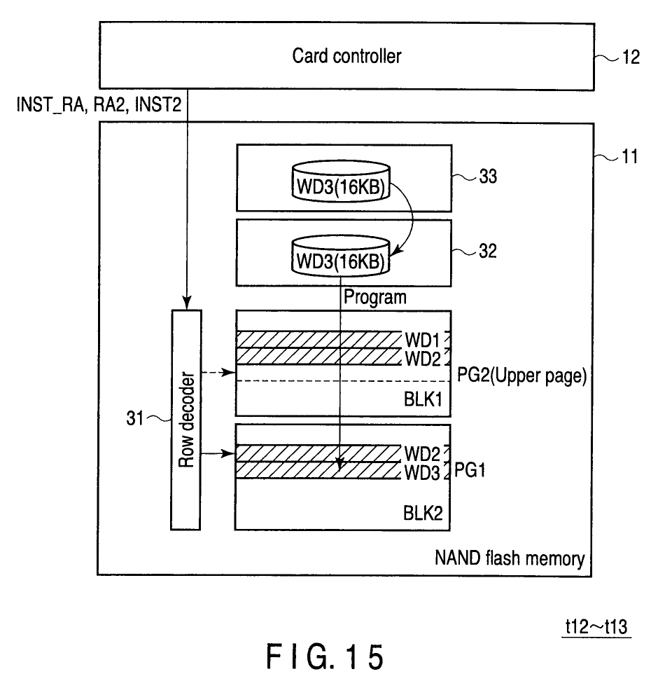

Now, the operation between times t12 and t13 will be described with reference to FIGS. 11 and 15. As shown in FIGS. 11 and 15, write data WD3 is transferred from the data cache 33 to the page buffer 32. The already issued first row address RA1 corresponds to page PG2 in the first memory block BLK1, that is, the upper page. Thus, the card controller 12 issues and outputs the row address change instruction INST_RA and the second row address RA2 to the flash memory 11. Subsequently, the card controller 12 issues and outputs the second write instruction INST2=“10H” to the flash memory 11. The second row address RA2 is assumed to correspond to, for example, page PG1 in the second memory block BLK2.

In the flash memory 11, in response to the issued row address change instruction INST_RA, the row decoder 31 selects page PG1 in the second memory block BLK2 in place of page PG2 in the first memory block PG1. Thus, write data WD3 is written to page PG1 in the second memory block BLK2.

(Between Times t13 and t18)

The operation between times t13 and t18 is similar to that between times t8 and t13. That is, between times t13 and t17, data WD3 programmed on page PG1 in the second memory block BLK2 is copied to page PG2 in the first memory block BLK1. Then, after the copy operation, write data WD4 is written to page PG3 in the first memory block BLK1. Of course, the second write instruction INST2 issued to allow write data WD3 to be copied to the upper page is the cache program command “15H”.

### <Effects>

The memory system configured as described above exerts the following effects.

(1) Data Write Speed can be Improved.

In the memory system according to the present embodiment, as shown in FIG. 11, if the final page for the programming operation is the upper or middle page in the first memory block BLK1, the data is temporarily held in the second memory block BLK2. That is, the second memory block BLK2 is used as a cache region. The second memory block BLK2 holds data as binary values. On the other hand, if the final page is the lower page in the first memory block BLK1, the data is programmed into the first memory block BLK1 directly. That is, the write data provided by the host apparatus 2 is programmed on the lower page in the first memory block BLK1 or the second memory block BLK2.

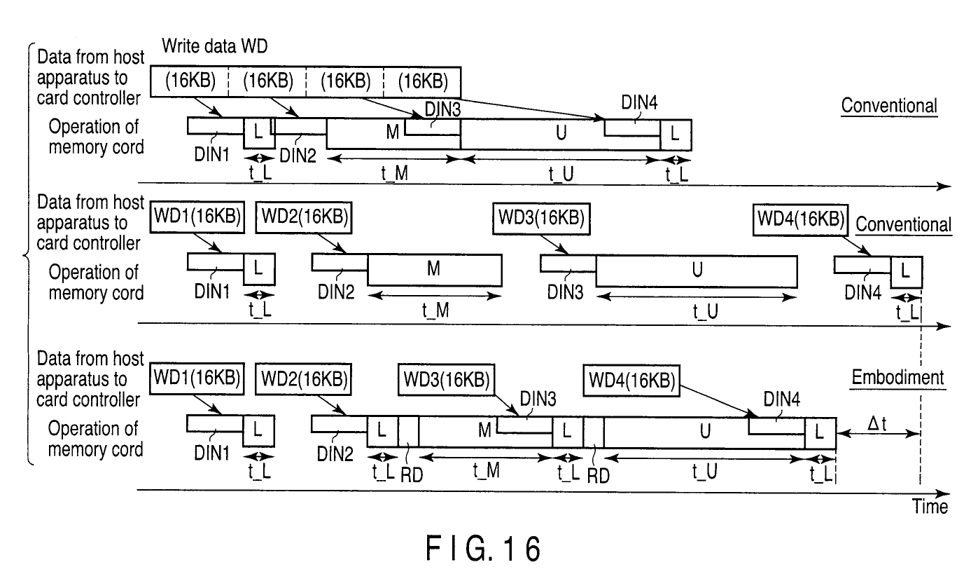

Thus, the data write speed can be improved. The present effect will be described below with reference to FIG. 16. FIG. 16 is a timing chart showing the flow of the operation of a conventional memory system and the memory system according to the present embodiment. FIG. 16 shows the flow of data from the host apparatus to the card controller 12 and the flow of the operation in the memory card 1 for each of the memory systems. The timing chart shown in FIG. 16 shows a case of the conventional configuration where the write data has a large size (the data size is 4 pages), a case of the conventional configuration where the write data has a small size (the data size is equal to or smaller than 1 page), and a case of the present embodiment where the write data has a small size (the data size is equal to or smaller than 1 page). The present embodiment is as shown in FIG. 11.

First, the case with the large data size will be described. As shown in FIG. 16, the host apparatus 2 transfers write data of (16×4)=64 KB to the card controller 12. The write data is then programmed into order of the lower page PG0, the middle page PG1, the upper page PG2, and the lower page PG3. The data transfer from the card controller 12 to the data cache 33 (this operation is denoted by DINi in FIG. 16; i is a natural number) can be performed during programming of the last transferred data (DIN(i−1)). Thus, the data can be quickly programmed without time loss. If the lower page is final, this also applies to the present embodiment.

Now, the case of the conventional configuration where the write data has a small size will be described. The conventional memory system does not have the function of issuing the row address change instruction or the second row address. Thus, given that write data WD1 is written to the lower page PG0, the write data WD2 is written to the middle page PG1 as shown in FIG. 16 (this operation is denoted by “M” in FIG. 16). Thereafter, the write to the middle page PG1 is finished to make the NAND flash memory accessible. Next write data WD3 is then transferred from the host apparatus 2 to the card controller 12. Then, write data WD3 is written to the upper page PG2 (this operation is denoted by “U” in FIG. 16). Thereafter, the write to the upper page PG2 is finished to make the NAND flash memory accessible. Next write data WD4 is then transferred from the host apparatus 2 to the card controller 12.

As described above, a write access needs to wait for the last write access to complete the write operation. Thus, disadvantageously, the reduced data size of the write data increases the write time. This is particularly significant for multilevel NAND flash memories.

In general, in a multilevel NAND flash memory, the time required for write varies significantly depending on the page. For example, for an 8-level NAND flash memory, time t_L required to write data to the lower page is about 200 μs. Time t_M required to write data to the lower page is about 1000 μs. Time t_U required to write data to the upper page is about 5,000 μs.

That is, to receive write data as shown in FIG. 16, the conventional memory system needs to waits for at least t_M=1,000 μs after receiving write data WD2. To receive write data WD4, the conventional memory system needs to wait for at least t_U=5,000 μs after receiving write data WD3. That is, if the write ends with the middle or upper page, the duration until the next data can be received is much longer than in the case where the write ends with the lower page. This disadvantageously reduces the write speed.

In this regard, the memory system according to the present embodiment, if the write operation ends with the middle or upper page, the data is written to the second memory block BLK2 (cache region), which holds the data in binary form. Thus, the time required for the write is only t_L=200 μs. This enables succeeding write accesses to be quickly dealt with.

Furthermore, the data written to the second memory block BLK2 needs to be copied to the first memory block BLK1 before the write operation of the next data. However, this copy operation can overlap the transfer period for the next write data. Moreover, the data transfer from the card controller 12 to the flash memory 11 (this operation is denoted by DINi in FIG. 16) can be performed simultaneously with the operation of copying the preceding write data. Consequently, the copy operation does not significantly affect the write time.

As a result, the data write speed in the memory system can be increased. Even if the same data is written in both memory systems as shown in FIG. 16, the memory system according to the present embodiment can finish the write operation time Δt earlier than the conventional memory system.

Furthermore, the use of the row address change instruction enables an increase in the speed of the above-described operation. That is, if the card controller 12 does not have the row address change instruction, when an attempt is made to write the write data to a memory block BLK different from the one indicated by the initial row address (first row address), the card controller needs to transfer the write data to the page buffer again. Specifically, to change the row address, the card controller first outputs a reset instruction in order to cancel the first write instruction. The card controller then issues the first write instruction and a new first row address. The card controller then re-inputs the data to the page buffer. The card controller finally issues the second write instruction.

However, the use of the row address change instruction eliminates the need to re-transfer the data to the page buffer, thus improving the data write speed.

### Second Embodiment

Now, a semiconductor device according to a second embodiment of the present invention will be described. The present embodiment uses write data remaining in the data cache 33 or the page buffer 32, for the copy operation in the above-described first embodiment. Only the differences of the second embodiment from the first embodiment will be described below.

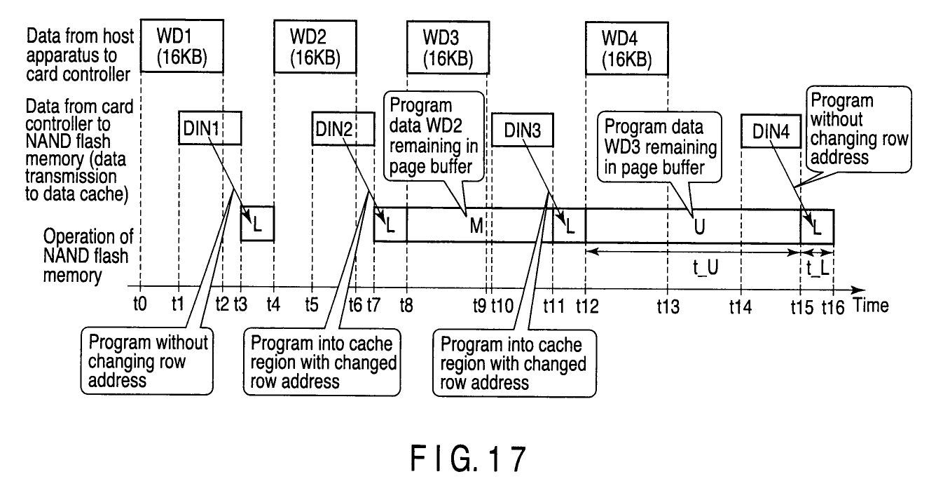

FIG. 17 is a timing chart showing the flow of processing in a memory system according to the present embodiment. FIG. 17 shows the flow of data from the host apparatus 2 to the memory controller 12 in the memory card 1, the flow of data from the memory controller 12 to the data cache 33 in the NAND flash memory 11, and the flow of the operation of the NAND flash memory 11. As in the case of FIG. 11, in FIG. 17, the data size of one page is 16 KB, and the host apparatus 2 makes four write accesses for page-sized data. In the description below, differences of FIG. 17 from FIG. 11 are noted.

As shown in FIG. 17, between times t7 and t8, write data WD2 is programmed into the second memory block BLK2. This operation corresponds to FIG. 13. Then, in the present embodiment, the read from the second memory block BLK2 is no longer performed. Instead, since write data WD2, used in the last program operation, probably remain in the data cache 33 or the page buffer 32, this data is utilized again to perform programming (between times t8 and t11).

An operation of copying write data WD3 is similarly performed. Since between times t11 and t12, the data cache 33 or the page buffer 32 holds write data WD3, this is utilized again to perform the programming between times t12 and t15.

The memory system configured as described above exerts an effect (2) in addition to the effect (1) described in the first embodiment.

(2) The Data Write Speed can further be Improved.

The memory system according to the present embodiment programs the write data in the second memory block BLK2 and then programs the write data remaining in the data cache 33 or the page buffer 32 to the first memory block BLK1. That is, the write data transferred from the card controller 12 is utilized for the two program operations.

Thus, when data is copied from the second memory block BLK2 to the first memory block BLK1, there is no need to read data from the second memory block BLK2. That is, the present embodiment eliminates the need for the processing between times t8 and t9 and the processing between times t13 and t14. This allows the operation of programming data to the first memory block BLK1 to be quickly started after the operation of programming data to the second memory block BLK2. This enables a further increase in data write speed.

As described above, in the semiconductor device according to the first and second embodiments, the 8-level NAND flash memory includes the memory block holding 1-bit data as a cache block for the memory blocks each holding 3-bit data. If the final page of the write data is the upper or middle page, in other words, if the final page corresponds to the bit requiring a long time for write, then the data is temporarily written to the cache block. Therefore, the data write speed can be increased.

The above-described embodiments are applicable to, for example, a memory system including a file system. The file system refers to a scheme of managing files (data) recorded in the memory, for example, a File Allocation Table (FAT) file system. The file system specifies a method of creating directory information on files and folders in the memory, a method of moving and deleting the files and folders, a scheme of recording data, and the location and utilizing method of a management region.

The memory space in the flash memory 11 including the FAT file system is roughly divided into a user data region and a management region. The user data region is a region in which net data written by the user is stored. The management region includes, for example, a region in which boot information is stored, a region in which partition information is stored, a region in which information indicating at which address each data is stored is stored, and a region in which information on root directly entries is stored. The user data region is managed in small units called clusters or allocation units. If for example, this unit is 16 Kbytes and the host apparatus issues write instructions in cluster unit, even when data larger than the cluster size is written to the memory, every 16 Kbytes of data is consecutively written to the memory. Even in this case, the technique according to the above-described embodiments can be used to perform high-speed write operations.

In the above-described embodiments, by way of example, the page-sized data is programmed as shown in FIGS. 11 and 17. However, data transferred from the host apparatus 2 may be smaller than the page size. Additionally, although not described above in the embodiments, each page may contain a redundancy section and a management data storage section. That is, the page may contain not only net data but also parity data or the like.

The above-described embodiments relate to the 8-level NAND flash memory by way of example. However, the flash memory has only to be of a multilevel NAND type. That is, each of the memory cell transistors MT in the first memory block BLK1 may hold multilevel data of 2, 4, or 5 bits. If the memory cell transistor MT holds 2-bit data, that is, if the lower page and the upper page are assigned to each memory cell transistor MT, then the time required for write is, for example, t_L=200 μs and t_U=3000 μs. As the time required for write varies more greatly depending on the bit to be programmed as described above, more significant effects are exerted.

The condition under which the row address change instruction is issued is not limited to the one that the final page is other than the lower page. For example, the issuance of the row address change instruction may be avoided when the final page is the middle page. Which of the bits corresponds to the final page when the row address change instruction is issued can be appropriately selected. However, at least if the final page is the most significant bit, in other words, if the final page is the bit requiring the longest time for write, the row address change instruction is desirably issued.

After copied to the first memory block BLK1, the data programmed into the second memory block BLK2 may be held instead of being erased. In this case, the data in the second memory block BLK2 can be used as spare data for the data in the first memory block BLK1. Thus, in this case, the reliability with which data is held in the flash memory can be improved.

In the above-described embodiments, by way of example, the time t_L, t_M, and t_U required to write data corresponds to the period from the time when the second write instruction is provided to the NAND flash memory 11, until the verification is completed through the programming and verification repeatedly performed on the memory cell transistors MT. The verification is finished when the threshold of the memory cell transistor MT is determined to reach the desired value through the programming of the data or when the number of the repetitions reaches a predetermined value.

However, the time t_L, t_M, and t_U required for write may be defined as the period from the time when the second write instruction is provided, that is, when the NAND flash memory 11 becomes busy state, until the NAND flash memory 11 get back ready state. The busy state refers to the state in which the NAND flash memory 11 does not accept data from the memory controller 12. This will be described below.

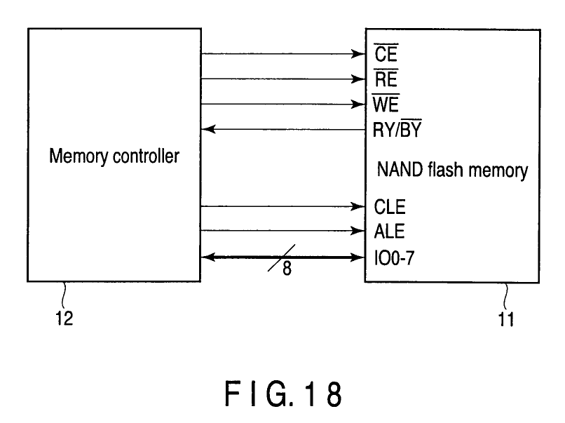

FIG. 18 is a block diagram of the memory card 1 showing signals transmitted between the NAND flash memory 11 and the memory controller 12. As shown in FIG. 18, the memory controller 12 provides the NAND flash memory 11 with a chip enable signal /CE, a read enable signal /RE, a write enable signal /WE, a command latch enable signal CLE, and an address latch enable signal ALE.

The chip enable signal /CE is made low when the memory controller 12 accesses the NAND flash memory 11.

The read enable signal /RE is made low when the memory controller 12 reads data from the NAND flash memory 11. Setting /RE=Low allows the NAND flash memory 11 to output, for example, 8-bit data IO0 to IO7.

The write enable signal /WE is made low when the memory controller 12 writes data to the NAND flash memory 11. Setting /WE=Low allows the NAND flash memory 11 to retrieve the data IO0 to IO7 output by the memory controller 12.

When /WE is made low, the command latch enable signal CLE indicates whether or not the data input to the NAND flash memory 11 is a command. That is, if CLE=High, the data IO0 to IO7 is a command.

When /WE is made low, the address latch enable signal ALE indicates whether or not the data input to the NAND flash memory 11 is an address. That is, if ALE=High, the data IO0 to IO7 is an address.

The NAND flash memory 11 provides a ready/busy signal RY/BY to the memory controller 12. The ready/busy signal RY/BY indicates the state of the NAND flash memory 11. If RY/BY=High, the NAND flash memory 11 is ready. If RY/BY=Low, the NAND flash memory 11 is busy. When RY/BY=High, the memory controller 12 inputs data, a command, or an address to the NAND flash memory 11.

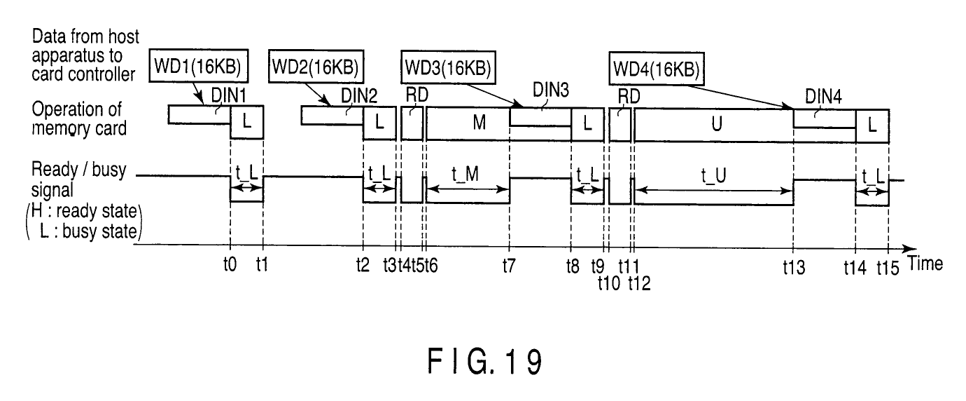

FIG. 19 is a timing chart according to the first embodiment shown in FIG. 16 and a corresponding time chart for the ready/busy signal.

As shown in FIG. 19, at time t0, the second write instruction INST2=“10H” is input. Then, the NAND flash memory 11 becomes busy. The ready/busy signal RY/BY is made low. At time t1, the writing (programming and verification) of write data WD1 is finished. Then, the NAND flash memory 11 becomes ready again, and the ready/busy signal RY/BY is made high.

At time t2, the second write instruction INST2=“10H” is input. Then, the NAND flash memory 11 becomes busy. The ready/busy signal RY/BY is made low. At time t3, the writing (programming and verification) of write data WD2 to the second memory block BLK2 is finished. Then, the NAND flash memory 11 becomes ready again.

When the NAND flash memory 11 becomes ready at time t3, the card controller 12 issues and outputs the read command to the NAND flash memory 11. The read command is an instruction to read the second write data WD2 written to the second memory block BLK2. In response to this, the NAND flash memory 11 becomes busy to perform the read operation. At time t5, the read is completed. Then, the NAND flash memory 11 becomes ready again.

When the NAND flash memory 11 becomes ready at time t5, the card controller 12 issues the second write instruction INST2=“15H”. The second write instruction INST2=“15H” is an instruction to write the second write data WD2 to the first memory block BLK1. In response to this, the NAND flash memory 11 becomes busy at time t6 to execute the cache programming on the second write data WD2.

For example, at time t7, the NAND flash memory 11 is enabled to accept data, for example, the data cache 33 becomes empty. Then, the NAND flash memory 11, on which the write is being executed, becomes ready (RY/BY=High). In response to this, the card controller 12 inputs next write data WD3 and the second write instruction INST2=“10H” to the NAND flash memory 11.

Once the writing of the second write data WD2 has finished, the NAND flash memory 11 becomes busy again to write the third write data WD3 to the second memory block BLK2. The subsequent operation is similar to that performed between times t3 and t9.

In the above-described operation, the time required for the write may be defined as the period from the time when the NAND flash memory 11 becomes busy until the NAND flash memory 11 becomes ready again. Then, the time t_M required to write the middle page corresponds to the period between times t6 and t7. The time t_U required to write the upper page corresponds to the period between times t12 and t13.

In the example in FIG. 19, the read command is issued, for example, between times t3 and t4 and between times t9 and t10. However, the card controller 12 may issue the read command to the NAND flash memory 11 without the need to wait for the NAND flash memory 11 to become ready. In this case, after the write to the second memory block BLK2 is finished, the read operation continues to be performed without the need for a shift to the ready state.

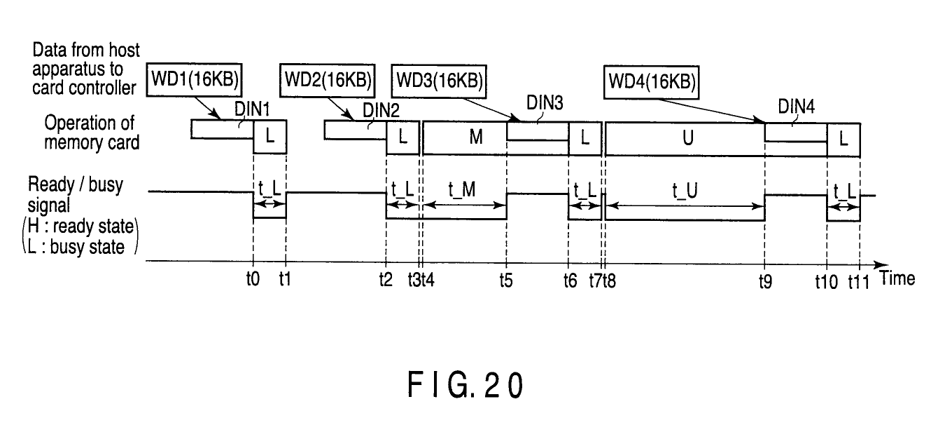

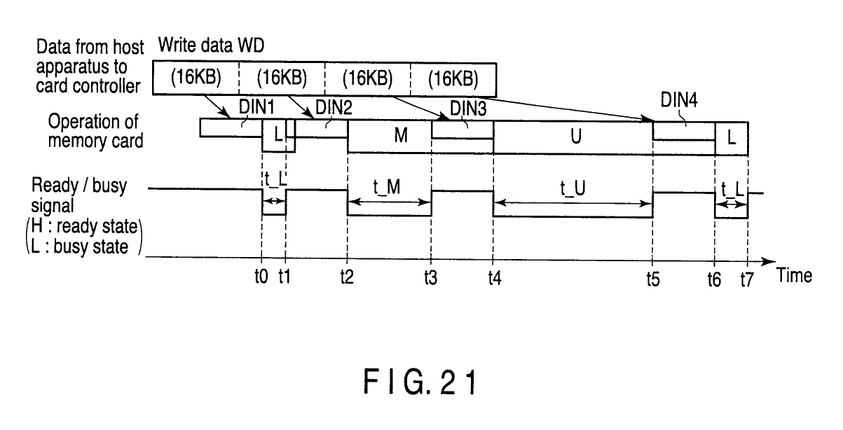

FIG. 20 is a timing chart of the ready/busy signal according to the above-described second embodiment. FIG. 21 is a timing chart for a case where large-sized data covering a plurality of pages is written to the memory. Each of the first three (16 Kbytes×3) data in FIG. 21 is written using the cache program command “15H”.

In the above-described embodiments, the flash memory 11 includes the data cache 33. However, the data cache 33 may be omitted from the flash memory 33. However, in this case, after the programming is completed, the data transfer from the card controller 12 to the flash memory 11 is carried out (DIN). That is, even with any succeeding data, the write operation is performed using the normal program command “10H”. Thus, the data cache 33 is desirably provided in terms of an increase in operating speed.

The above-described embodiments are significantly effective if the NAND bus 15 has a larger bus width (data transfer rate) than the host bus 14. This is because the write performance can be generally improved by allowing the program time to overlap time resulting from the difference in data transfer rate between the NAND bus 15 and the host bus 14.

The memory card 1 described above in the embodiments is, for example, an SD™ card. However, the memory card 1 may be a semiconductor memory device embedded to the host apparatus 2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor device comprising:
a nonvolatile semiconductor memory including a first memory block having a plurality of memory cells configured to hold data of at least 2 bits, and a second memory block having a plurality of memory cells configured to hold 1-bit data, the nonvolatile semiconductor memory being configured such that data is programmed into the first and second memory blocks in units of page which is a set of a plurality of the memory cells, each of the pages in the first memory block being assigned to a corresponding bit of the held data, time required for write varying depending on the bit; and
a controller supplying write data received from a host apparatus to the nonvolatile semiconductor memory and instructing the nonvolatile semiconductor memory to program the write data into the first memory block or the second memory block for each of the pages, the controller instructing the nonvolatile semiconductor memory to program the data on any of the pages in the second memory block if a final page of the write data corresponds to the bit requiring the longest time for the write.

2. The device according to claim 1, wherein the controller is configured to transfer data in the page unit and a first row address specifying any of the pages in the first memory block, to the nonvolatile semiconductor memory and to issue a change instruction to change the transferred first row address and a second row address specifying any of the pages in the second memory block,
if the first row address corresponding to the final page corresponds to the bit requiring the longest time for the write, then after transferring the data and the first row address, the controller issues and supplies the change instruction and the second row address to the nonvolatile semiconductor memory, and
the nonvolatile semiconductor memory executes the programming on the first page corresponding to the first row address when the change instruction is not issued, and executes the programming on the second page corresponding to the second row address when the change instruction is issued.

3. The device according to claim 2, wherein after executing the programming on the second page, the nonvolatile semiconductor memory copies the data programmed on the second page to the first page.

4. The device according to claim 3, wherein the nonvolatile semiconductor memory further includes a buffer circuit configured to transmit and receive data to and from the controller in the page unit and to hold one page of data,
during the programming, the data transferred from the controller to the buffer circuit is programmed into the memory cells, and
to copy the data on the second page to the page corresponding to the first row address, the nonvolatile semiconductor memory uses the data transferred to the buffer circuit when the programming is executed on the second page, to execute the programming on the first page.

5. The device according to claim 1, further comprising a first bus connecting the nonvolatile semiconductor memory and the controller together,
wherein the first bus has a larger bus width than a second bus connecting the controller and the host apparatus together.

6. A semiconductor device comprising:
a nonvolatile semiconductor memory including a first memory block and a second memory block each having a plurality of memory cells configured to hold data, the nonvolatile semiconductor memory being configured to program data into the first and second memory blocks in page unit, the first memory block offering a write speed varying with the page; and
a controller supplying write data to the nonvolatile semiconductor memory and instructing the nonvolatile semiconductor memory to program the write data into the first memory block or the second memory block, the controller instructing the nonvolatile semiconductor memory to program the data into the second memory block if a final page of the write data corresponds to the page offering the lowest write speed in the first memory block.

7. The device according to claim 6, wherein the controller is configured to transfer data in the page unit and a first row address specifying any of the pages in the first memory block, to the nonvolatile semiconductor memory and to issue a change instruction to change the transferred first row address and a second row address specifying any of the pages in the second memory block,
if the first row address corresponding to the final page corresponds to the page offering the lowest write speed, then the controller issues and supplies the change instruction and the second row address, and
the nonvolatile semiconductor memory executes the programming on the first page corresponding to the first row address when the change instruction is not issued, and executes the programming on the second page corresponding to the second row address when the change instruction is issued.

8. The device according to claim 7, wherein after executing the programming on the second page, the nonvolatile semiconductor memory copies the data programmed on the second page to the first page.

9. The device according to claim 8, wherein the nonvolatile semiconductor memory further includes a buffer circuit configured to transmit and receive data to and from the controller in the page unit and to hold one page of data,
during the programming, the data transferred from the controller to the buffer circuit is programmed into the memory cells, and
to copy the data on the second page to the page corresponding to the first row address, the nonvolatile semiconductor memory uses the data transferred to the buffer circuit when the programming is executed on the second page, to execute the programming on the first page.

10. The device according to claim 6, further comprising a first bus connecting the nonvolatile semiconductor memory and the controller together,
wherein the first bus has a larger bus width than a second bus connecting the controller and the host apparatus together.

11. The device according to claim 6, wherein each of the memory cells in the first memory block is configured to hold data of at least 2 bits, and
the write speed for the page varies depending on to which of the bits the page corresponds.

12. The device according to claim 11, wherein the each of the memory cells in the first memory block is configured to hold data of 1 bit.

13. A data write method for a nonvolatile semiconductor memory including a first memory block offering a write speed varying with page and a second memory block, the method comprising:
transmitting a first row address specifying any of the pages in the first memory block to the nonvolatile semiconductor memory;
after transmitting the first row address, transmitting data to the nonvolatile semiconductor memory;
if after the transmission of the data, no data to be transmitted to the nonvolatile semiconductor memory remains, and the first row address corresponds to the page offering the lowest write speed in the first memory block, transmitting a row address change instruction and a second row address specifying any of the pages in the second memory block to the nonvolatile semiconductor memory; and
after the transmission of the second row address, transmitting a write instruction to program the data on a page specified by the second row address, to the nonvolatile semiconductor memory.

14. The method according to claim 13, further comprising:
if after the transmission of the data, any data to be transmitted to the nonvolatile semiconductor memory remains, transmitting a write instruction to program the data on a page specified by the first row address, to the nonvolatile semiconductor memory, without transmitting the row address change instruction and the second row address.

15. The method according to claim 13, wherein the whether or not any data to be transmitted remains is determined depending on whether or not a write access end notification or a suspend instruction has been received from a host apparatus.

16. The method according to claim 13, further comprising, after the transmission of the write instruction, programming the data on the page specified by the second row address; and
after the programming of the data, coping the data to the page specified by the first row address.

17. The method according to claim 13, wherein each of the memory cells in the first memory block is configured to hold data of at least 2 bits, and
the write speed for the page varies depending on to which of the bits the page corresponds.

18. The method according to claim 17, wherein each of the memory cells in the second memory block is configured to hold data of 1 bit.
